(19) United States
(12) Patent Application Publication
(10) Pub. No.: US 2021/0192620 A1
(43) Pub. Date: Jun. 24, 2021

(54) MACHINE LEARNING-BASED DIGITAL EXCHANGE PLATFORM

(71) Applicant: EdenLedger, Inc. d/b/a FanVestor, San Francisco, CA (US)

(72) Inventor: Mikhail Golomb, San Francisco, CA (US)

(73) Assignee: EdenLedger, Inc. d/b/a FanVestor, San Francisco, CA (US)

(21) Appl. No.: 17/128,001

(22) Filed: Dec. 18, 2020

Related U.S. Application Data
(60) Provisional application No. 62/950,038, filed on Dec. 18, 2019.

(51) Int. Cl. G06Q 40/04; G06Q 30/02; G06N 20/00; H04L 9/32

(52) U.S. Cl. CPC G06Q 40/04; G06Q 30/0282; H04L 2209/38; G06N 20/00; H04L 9/3236; G06Q 30/0204

(57) ABSTRACT

Obtaining a plurality of different digital asset types, at least a first digital asset type of the plurality of different digital asset types comprising a predefined digital asset type, and at least a second digital asset type of the plurality of different digital asset types comprising a dynamically defined digital asset type. Converting the first digital asset type to a first digital asset object based on the predefined digital asset type and an object model. Converting the second digital asset type to a second digital asset object based on the dynamically defined digital asset type and the object model. Identifying, based on machine learning, a first candidate set of users of a plurality of users to potentially be issued first digital asset units associated with a first brand, each the first digital asset units comprising a corresponding instance of the first digital asset object. Identifying, based on machine learning, a second candidate set of users of the plurality of users to potentially be issued second digital asset units associated with a second brand, each the second digital asset units comprising a corresponding instance of the second digital asset object. Issuing at least one first digital asset unit associated with the first brand to at least a first user of the first candidate set of users. Issuing at least one second digital asset unit associated with the first brand to at least a second user of the second candidate set of users. Recording the issuing of the first digital asset units and the issuing of the second digital asset units in a distributed ledger. Updating the distributed ledger based on one or more events.

### CROSS-REFERENCE TO RELATED APPLICATIONS

The present application claims priority to U.S. Provisional Patent Application Ser. No. 62/950,038, filed Dec. 18, 2019 and entitled “A Fan Engagement Ecosystem that Enables Crowdsources Fundraising for the Sports, Entertainment, Media, Arts, and Fashion Industries,” the contents of which are hereby incorporated by reference herein.

### BRIEF DESCRIPTION OF THE DRAWINGS

FIG. 1 is a diagram of an example of a system for secure machine learning-based digital exchange of different types of assets using a machine learning-based digital exchange platform system.

FIG. 2 is a diagram of an example of a machine learning-based digital exchange platform system.

FIG. 3 is a flowchart of an example of a method of operation of a machine learning-based digital exchange platform system.

FIG. 4 is a flowchart of an example of a method of using machine learning to estimate digital asset value scores and suggest and process trades of different types of digital assets on a blockchain.

FIG. 5 is a flowchart of an example of a method of transferring digital assets from the machine learning-based digital exchange platform system to a third-party exchange system.

FIG. 6 is a flowchart of an example of a method of issuing asset rewards based on machine learning.

FIG. 7 is a flowchart of an example of a method of managing a brand campaign.

FIG. 8 is a screenshot of an example of an interface associated with a crowdsourced selection of a representative for a brand.

### DETAILED DESCRIPTION

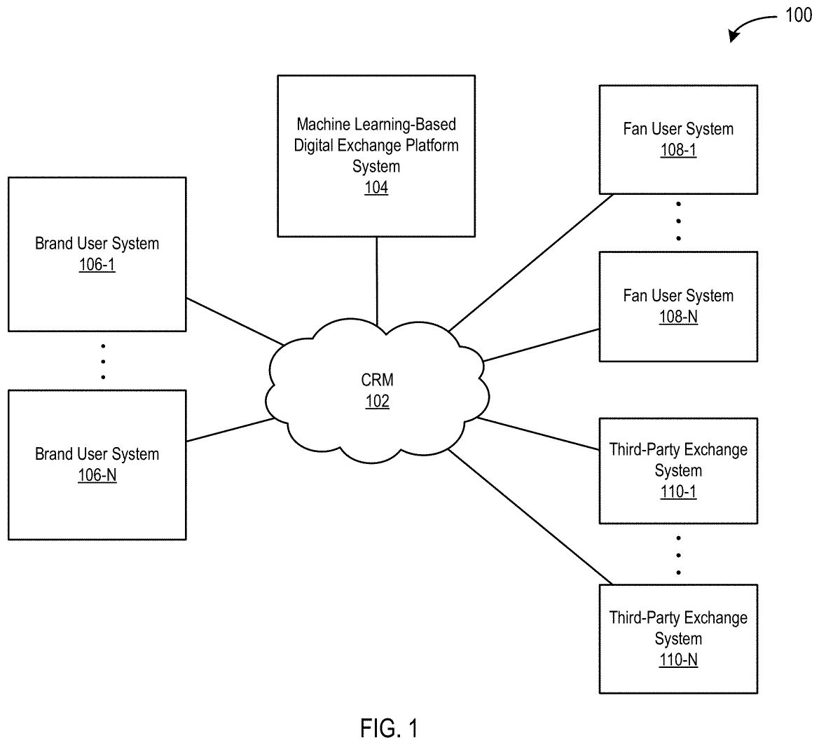

FIG. 1 is a diagram 100 of an example of a system for secure machine learning-based digital exchange of different types of assets using a machine learning-based digital exchange platform system. The diagram 100 includes a computer-readable medium (CRM) 102, a machine learning-based digital exchange platform system 104 coupled to the CRM 102, brand user systems 106-1 to 106-N (individually, the brand user system 106, collectively, the brand user systems 106) coupled to the CRM 102, fan user systems 108-1 to 108-N (individually, the fan user system 108, collectively, the fan user systems 108) coupled to the CRM 102, and third-party exchange systems 110-1 to 110-N (individually, third-party exchange system 110, collectively, the third-party exchange systems 110) coupled to the CRM 102.

The CRM 102 in intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g., “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The machine learning-based digital exchange platform system 104 can function to provide secure machine-learning digital exchange of a different types of digital assets (or, simply, assets). Functionality of the machine learning-based digital exchange platform system 104 can be performed by one or more servers (e.g., a cloud-based server) and/or other computing devices. The machine learning-based digital exchange platform system 104 can be implemented by a cloud-computing platform. As used herein, a cloud-computing platform can refer to an on-demand cloud-computing platform, a “serverless” cloud-computing platform, and/or other cloud-computing platform.

In a specific implementation, the machine learning-based digital exchange platform system 104 can function to provide secure machine learning-based digital exchange of different types of assets using a distributed ledger. For example, the machine learning-based digital exchange platform system 104 can provide a digital exchange for many different types of assets on a single blockchain, whereas typical blockchain systems only allow for one type of asset on the blockchain (e.g., Bitcoin).

In a specific implementation, assets can include any underlying (e.g., “real world”) asset and can represent any unit of value. Assets can be of any asset type, such as registered or regulated securities (Regulation Crowdfunding (CF), Regulation A (Reg A), Regulation A+(Reg A+), Regulation D (Reg D), Regulation S (Reg S)), SEC-compliant financial instruments (e.g., such as debt, equity, derivatives), government currencies, corporate bonds, loyalty rewards and other rewards, perks, experience offerings, and/or the like. Assets can be predefined (e.g., based on SEC requirements) or can be dynamically defined (e.g., by a user). In a specific implementation, an asset type defines, or represents, a group of assets that are categorized based on similar attributes or characteristics (e.g., stock, bonds, options, exchange traded funds, virtual rewards, virtual perks, shares, and the like).

In a specific implementation, the machine learning-based digital exchange platform system 104 can function to generate, issue, and exchange assets between the machine learning-based digital exchange platform system 104 and users, and also directly between users of the machine learning-based digital exchange platform system 104. For example, a brand user (e.g., a representative of a company, a representative of a celebrity) for a brand (e.g., a company, a celebrity or other person) can register with the machine learning-based digital exchange platform system 104 to issue assets which can be obtained (e.g., purchased) by fan users through the machine learning-based digital exchange platform system 104. The fan users can then exchange these assets on the machine learning-based digital exchange platform system 104 (e.g., buying and selling in the manner of a stock exchange, albeit as modified as described herein), or they may buy, sell, or trade assets to other users directly (e.g., Joe can trade an asset directly to John for a different asset). This can, for example, provide fractional ownership and liquidity to fan users (e.g., allowing fans to invest in institutional quality assets and equities at a reduced entry point and with a shared, mitigated risk exposure) in a more computationally efficient manner than traditional exchanges.

Accordingly, the machine learning-based digital exchange platform system 104 can provide registered securities and perks, rewards, and experience offerings to new or existing brands that have a fan and or social media following for the purposes of raising capital for projects, as well as to create an initial public offering (such as, for example, proprietary initial influencer offerings (IIOs)/initial brand offerings (IBOs)). By and through these asset offerings, the machine learning-based digital exchange platform system 104 serves to increase overall financial brand valuations and facilitates a deeper fan-to-brand relationship. In addition, the machine learning-based digital exchange platform system 104 provides a secure and computationally efficient and intelligent exchange system with fractional ownership for fan users (e.g., thereby allowing fans to more efficiently and securely invest in institutional quality assets and equities).

As used herein, the term fan or fan user can refer to an aficionado, follower, or supporter who is enthusiastically devoted to a brand, such as a brand related to an athlete, sports team, sport venue, sport agency, sport owner, e-gamer, e-sport team, entertainer, comedian, musician, music label, music promoter, music band, movie and/or tv actor/actress, movie/tv producer/director, movie/tv talent agency, artist, model, fashion line, fashion designer, online influencer, performance/entertainment/event venue, talent agency, and the like. Brand can refer to a company (e.g., a music production company), a person (e.g., a musician), or associated projects (e.g., an upcoming album of a musician).

In a specific implementation, the machine learning-based digital exchange platform system 104 can function to generate and manage brand campaigns (or, simply, campaigns). For example, a brand user of the machine learning-based digital exchange platform system 104 can create or select a brand and issue assets for that brand which can be obtained by fan users. The campaign can indicate characteristics and attributes of assets to be issued, indicate the number of assets to be issued, indicate particular fan users or types of fan users to be targeted for the campaign, and the like.

As discussed elsewhere herein, the machine learning-based digital exchange platform system 104 can handle different types of assets (e.g., whereas other exchanges and networks only handle one type of asset). In a specific implementation, the machine learning-based digital exchange platform system 104 can generate digital asset objects (or, simply, asset objects) from any type of asset, and then those asset objects can be exchanged on the machine learning-based digital exchange platform system 104. In this manner the machine learning-based digital exchange platform system 104 can be configured to exchange different types of assets without having to be specifically programmed to exchange each type of different asset. Rather, the machine learning-based digital exchange platform system 104 can be programmed to exchange asset objects, or more specifically, instances of asset objects, and various asset objects can correspond to any type of different asset. Accordingly, an asset object can be referred to as a universal asset object.

The brand user systems 106 can function to allow brand users to interact with the machine learning-based digital exchange platform system 104 (e.g., to create campaigns, issue assets, and the like). Functionality of the brand user systems 106 can be performed by one or more computing devices (e.g., personal computers, mobile devices).

The fan user systems 108 can function to allow fan users to interact with the machine learning-based digital exchange platform system 104 (e.g., obtain and exchange assets). Functionality of the fan user systems 108 can be performed by one or more computing devices (e.g., personal computers, mobile devices).

The third-party exchange systems 110 can function to exchange products and provide information that can be used to define asset types. For example, an eBay system can be a third-party exchange system 110. In another example, a Securities and Exchange Commission (SEC) system can be a third-party exchange system 110 that provides information and requirements that the machine learning-based digital exchange platform system 104 can use to define SEC-compliant asset types.

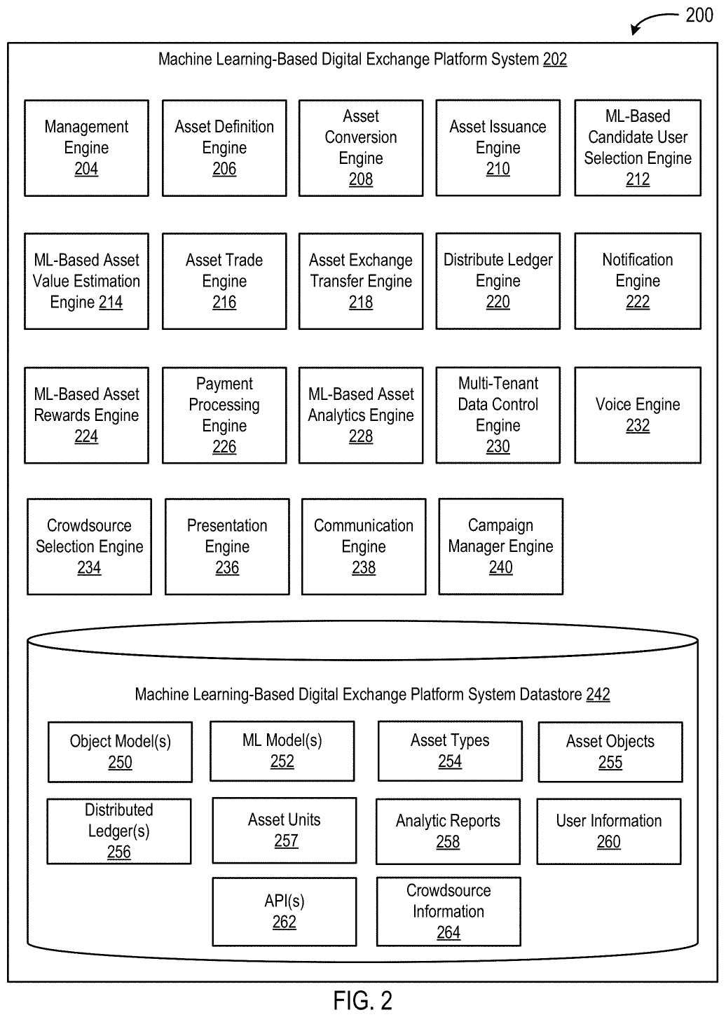

FIG. 2 is a diagram 200 of an example of a machine learning-based digital exchange platform system 202. The diagram 200 includes a management engine 204, an asset definition engine 206, an asset conversion engine 208, an asset issuance engine 210, a machine learning-based candidate user identification engine 212, a machine learning-based asset value estimation engine 214, an asset trade engine 216, an asset exchange transfer engine 218, a distributed ledger engine 220, a notification engine 222, a machine learning-based rewards engine 224, a payment processing engine 226, a machine learning-based analytics engine 228, a multi-tenant data control engine 230, a voice engine 232, a crowdsourced selection engine 234, a presentation engine 236, a communication engine 238, a campaign manager engine 240, and machine learning-based digital exchange platform system datastore 242.

The management engine 204 is intended to represent an engine that manages (e.g., create, read, update, delete, or otherwise access) objects models 250, machine learning models 252, digital asset types (or, simply, asset types) 254, digital asset objects (or, simply, asset objects) 255, distributed ledgers 256, digital asset units (or, simply, asset units) 257, analytic reports 258, user information 260, APIs 262, and/or crowdsource information 264. The management engine 204 can perform any of these operations manually (e.g., by a user interacting with a GUI) and/or automatically (e.g., triggered by one or more of the engines 306-320). Like other engines described herein, some or all the functionality of the management engine 204 can be included in and/or cooperate with one or more other engines (e.g., engines 206-240) and datastores (e.g., machine learning-based digital exchange platform system datastore 242).

In a specific implementation, the management engine 204 is intended to represent an engine that registers users on the machine learning-based digital exchange platform system 202. Users can include brand users (e.g., associated with brand user systems) and fan users (e.g., associated with fan user systems). The management engine 204 can generate and/or otherwise obtain user information 260. User information 260 can include name (e.g., John Doe), age, physical address, electronic mail addresses, social media account information, sex, education, net worth, marital status, whether the user has children, personal interests (e.g., movies, sports, music, and/or other hobbies, psychographic information, user account information for the machine learning-based digital exchange platform system 202 (e.g., username, password, tokens), and/or the like. The management engine 204 can generate interactive user profiles based on the user information 260. For example, a user profile can include some or all of the user information 260.

User information 260 for brand users can include some or all of the user information 260 discussed above. User information 260 for brand user can also include associated brands, industries, brand campaigns, and/or the like.

The asset definition engine 206 is intended to represent an engine that obtain, generates and/or defines asset types 254. Asset types 254 can be predefined or dynamically defined. Predefined assets types 254 can be generated by the asset definition engine 206 (e.g., without requiring user input) based on third-party information or requirements (e.g., SEC requirements obtained from an SEC third-party exchange system). Dynamically defined asset types 254 can be dynamically defined by the asset definition engine 206 in response to user input (e.g., by a brand user during a campaign management process). Whether predefined or dynamically defined, asset types 254 can include a variety of attributes or characteristics.

In a specific implementation, each asset type 254 has an asset type identifier which may be associated with an asset type of an underlying asset. For example, an asset type identifier can comprise a 512-bit string designed to be globally unique within one distributed ledger system (e.g., blockchain), and/or across multiple distributed ledger systems (e.g., formed by a plurality of connected machine learning-based digital exchange platform systems 104). Each asset type identifier can correspond to a set of rules for issuing units of that asset. In some embodiments, the asset type identifier can be determined by computing a cryptographic hash based on the set of corresponding rules. In a specific implementation, the determination of the asset type identifier can also include another identifier indicating an associated brand.

In a specific implementation, asset types 254 can also indicate an associated campaign, one or more brands, an initial value of the asset once issued, a total number of the asset types that can be issued, rewards or perks associated with asset type, and the like. For example, an asset type 254 can indicate an initial price (e.g., $1) that the asset unit 257 will be offered on the machine learning-based digital exchange platform system 104. This price can change as trading occurs.

The asset conversion engine 208 is intended to represent an engine that can convert an asset type 254 to an asset object 255 that can be used to issue asset units 257 which can be traded on the machine learning-based digital exchange platform system (e.g., by the asset trade engine 216, discussed further below). In a specific implementation, the asset conversion engine 208 uses an object model 250 to convert an asset type 254 to an asset object 255. More specifically, an object model 250 comprises a collection of elements such as typed objects, properties, and relationships. The collections can be structured in any suitable manner. The object model 250 allows the asset conversion engine 208 to map the asset type 254 to an existing asset object 255 or a new asset object 255. In a specific implementation, an asset type 254 may be stored relationally, as a text file, or other non-object-oriented format, and the asset objects 255 may be stored in an object-oriented format.

In some embodiments, the asset conversion engine 208 can also function to convert an asset object 255 back to an asset type 254 or other format. For example, if an asset object 255 or asset unit 257 is going to be transferred to a third-party exchange system, the asset conversion engine 208 can use the object model 250 to convert the asset units 257 and underlying asset object 255 to the original asset type 254 or other format that can be processed by the third-party exchange system.

In a specific implementation, an asset object 255 can be, or represent, a type of value that can be issued on a distributed ledger 257 (e.g., blockchain) as an asset unit 257 (e.g., an instance of an asset object 255). All units of a given asset can be fungible. Units of an asset can be transacted (e.g., associated with transactions) directly between users without the involvement of the issuer. Each asset object 255 and asset unit 257 can have a globally unique asset identifier. In a specific implementation, the issuer (e.g., a brand user interacting with the machine learning-based digital exchange platform system 104) can issue as many units as they want, as many times as they want.

The asset issuance engine 210 is intended to represent an engine that issues asset units 257 according to an asset object 255. The asset issuance engine 210 can issue asset units 257 as instances of corresponding asset objects 255. In one example, the asset issuance engine 210 can issue asset units 257 for a particular brand (e.g., a music album, a celebrity persona, or other project or campaign) that can be exchanged on the machine learning-based digital exchange platform system 104. The asset issuance engine 210 can be governed by the attributes or characteristics of the corresponding asset objects 255.

The machine learning-based candidate user identification engine 212 is intended to represent an engine that can identify a set of candidate users from among the users (e.g., fan users) of the machine learning-based digital exchange platform system 104. The candidate users can be candidates to be issued asset units 257 for a particular campaign, candidates for a trade of asset units 257, and the like. In a specific implementation, the machine learning-based candidate user identification engine 212 uses a machine learning model 252 and user information 260 to determine candidate users that are likely (e.g., above a threshold value) to obtain (e.g., purchase) a particular asset or asset type. For example, a musician can instruct the machine learning-based digital exchange platform system 104 to issue asset units 257 corresponding to the musician's upcoming album. Rather than only listing the asset units 257 on the machine learning-based digital exchange platform system 104, the machine learning-based candidate user identification engine 212 can utilize the user information 260 and one or more machine learning models 252 to predict which users would be interested in those asset units 257, and the machine learning-based digital exchange platform system 104 can notify those users directly of the offering. In a specific implementation, some or all of the user information can be weighted and/or provided as input to the one or more machine learning models.

As used in this paper, machine learning can use one more machine learning models 252 to provide predictions, estimations and decisions (e.g., without being explicitly programmed to so). Training data (e.g., labeled data) can be used to train the machine learning models 252. Each engine can each use one or more of the same or different types of machine learning models 252 (e.g., for different stages of operations). Different types of machine learning approaches and models 252 can be used. For example, the machine learning described in this paper can use neural networks, graph neural networks, deep learning, clustering, Bayesian networks, random forest, supervised learning (e.g., requiring a user or other information source to label pairs of training data), semi-supervised learning (e.g., active learning), k-nearest neighbor, and the like. In a specific implementation, a graph neural network can be particularly beneficial as it can efficiently handle large amounts of data, which can reduce computation time and/or computation resource requirements (e.g., processor requirements).

The machine learning-based asset value estimation engine 214 is intended to represent an engine that uses machine learning to estimate a value of an asset type 254, an asset object 255, or an asset unit. It will be appreciated that as used in the paper, reference to an “asset” can refer to an asset type 254, asset object 255, and/or an asset unit 257. As noted elsewhere herein, any number of different types of assets can be exchanged on the machine learning-based digital exchange platform system 104. Accordingly, it can be helpful to have an independent value score to estimate a value of an asset that can be compared against values of other assets regardless of their underlying asset type 254. In a specific implementation, the machine learning-based asset value estimation engine 214 estimates a value that has an absolute score (e.g., numerical) and/or a relative score. The score can be a numerical score, a vector score or the like. For example, a vector score can include a numerical value score (e.g., 10.3 on a scale of 1-100) and another numerical value indicating a confidence level of the estimation (e.g., 55 on a scale of 1-100). For example, high value scores can indicate a higher estimated value or worth, and a higher confidence level can indicate a higher confidence in the estimated value. Both value scores and confidence scores can be used to select candidate users. For example, some users may only respond to trade suggestions with estimated values that have a threshold confidence level. Value scores and confidence levels can be recorded in asset objects 255, asset units 257, and/or a distributed ledger 256.

In a specific implementation, the machine learning-based asset value estimation engine 214 uses a machine learning model 252 and an asset type 254 and user information 260 and/or exchange history (e.g., trading values) of similar assets to estimate a value of an asset. Similar assets can be assets with at least a threshold number of overlapping attribute values or which have attributes values within a threshold distance of each other. For example, asset X can be similar to asset Y if they are both associated with a music brand. In another example, asset C can be similar to asset X and asset Y if asset C is associated with a movie brand, since movie and music are both related to entertainment.

The asset trade engine 216 is intended to represent an engine that can process transactions. Transactions can include trades and exchanges of asset units. Transactions can occur between a user (e.g., fan user) and the machine learning-based digital exchange platform system 104, or directly between users In a specific implementation, the trade engine 216 can process trades (e.g., instruct the distributed ledger engine 220) to record a trade, and it can also suggest trades (e.g., to candidate users identified by the machine learning-based candidate user identification engine 212).

The asset exchange transfer engine 218 is intended to represent an engine that transfers assets to another exchange (e.g., third-party exchange system) and receive assets from another exchange (e.g., third-party exchange system). In a specific implementation, the asset exchange transfer engine 218 can instruct the asset conversion engine 208 to convert the asset to a format of the receiving exchange when transferring the asset out of the machine learning-based digital exchange platform system 104, and it can instruct the asset conversion engine 208 to convert an asset type 254, or other asset definition, based on requirements of another exchange, to an asset object 255 which can be instantiated into asset units 257 which can be exchanged on the machine learning-based digital exchange platform system 104. In a specific implementation, the asset exchange transfer engine 218 can use one or more application programming interfaces 262 (APIs) to transfer data between the machine learning-based digital exchange platform system 104 and third-party exchange systems

The distributed ledger engine 220 is intended to represent an engine that generates and manages one or more distributed ledgers 256 (e.g., one or more blockchains). For example, the distributed ledger engine 220 can add blocks to the distributed ledger (e.g., a block indicating an asset trade or other transaction), verify the authenticity of a transaction (e.g., prior to adding a corresponding block to the ledger), and/or other distributed ledger operations.

In a specific implementation, the distributed ledger engine 220 is intended to represent an engine that generates smart contracts between investors (e.g., fan users) and brand owners (e.g., brand users), as well as capable of generating smart contracts related to transactions occurring on the machine learning-based digital exchange platform system 104, wherein the distributed ledger is further capable of maintaining secure, trusted, and tamper-proof records.

The notification engine 222 is intended to represent an engine that can trigger, generate, transmit, and receive notification messages. Notification messages can include notifications of a suggested trade, notifications of responses to trade suggestion (e.g., accept, reject, NULL), user registration information (e.g., successful user registration), and the like. The notification engine 222 can monitor activity on the machine learning-based digital exchange platform system 104 in order to trigger actions based on events. Events can include trades, exchanges, changes in asset values, new assets being offered, assets expiring, campaigns terminating, new fan users being registered that may be of particular relevance to certain brand users, and the like.

In a specific implementation, the notification engine 222 can send notification messages to systems (e.g., fan user systems, brand user systems) regardless of the state of the receiving system. This can be helpful to ensure real-time, or near real-time, operation of the system. For example, the notification engine 222 can generate notification messages that include a wakeup signal. Accordingly, if a receiving system is an off state, standby state, or other state that is not an “on” state, the notification message can cause the receiving system to wake up and display the notification to the user.

The machine learning-based rewards engine 224 is intended to represent an engine that defines, generates, issues, and/or processes rewards. Rewards can be associated with asset types, asset objects, and/or asset units. For example, rewards can include monetary rewards, dividends, experiences, perks, and the like. In a specific implementation, rewards can be tiered. For example, tiers can be delineated based on a number or portion of assets of a brand owned by a fan user. Higher tiers can provide more valuable rewards, different types of rewards, a greater number of rewards, and the like.

In some embodiments, the machine learning-based rewards engine 224 utilizes machine learning models 252 to select or generate rewards. For example, a machine learning model 252 can predict the effectiveness of various rewards (e.g., based on how rewards affected an estimated value of similar assets), and then select rewards that are predicted to be the most effective (e.g., based on one or more threshold values) in causing users to obtain the corresponding asset.

The payment processing engine 226 is intended to represent an engine that facilitates cross-border financial transactions for project capitalization and investment liquidation purposes. The payment processing engine 226 can be further capable of facilitating peer-to-peer financial transactions between investors (e.g., fan users) and brand owners (e.g., brand users).

The machine learning-based analytics engine 228 is intended to represent an engine that generates analytic reports 258 utilizing artificial intelligence and machine learning to analyze data related to fans, investors, brand owners, influencers, content owners and distributors, telecommunication technology and service providers, and regulated securities transactions. The machine learning-based analytics engine 228 can analyze data obtained by the machine learning-based digital exchange platform system 104, such as fan behavior, social and emotional data, geographic and located-based data, financial status, and demographics in order to provide direct fan-to-brand analytics. The machine learning-based digital exchange platform system 104 can use the analytics to match potential investors (e.g., fan users or potential fan users) to brand owners (e.g., brand users or potential brand users).

The multi-tenant data control engine 230 is intended to represent an engine that provides cloud-based data control that allows fans (e.g., fan users), brands (e.g., brand users), influencers, content owners and distributors, telecommunication technology and service providers, and investors to manage their data in the machine learning-based digital exchange platform system 104 in a secure multi-tenant environment. The multi-tenant data control engine 230 can further provide data privacy and regulatory compliance mechanisms.

The voice engine 232 is intended to represent an engine that provides private branch exchange (PBX) features, telephone capabilities, and communication via SMS, MMS, Internet and web-based chat, podcast, Facebook, Slack, Skype, and other closed and open communication channels. The voice engine 232 can further include a fully functioning operator console, virtual meeting rooms management system, and a client portal with scheduling and reporting.

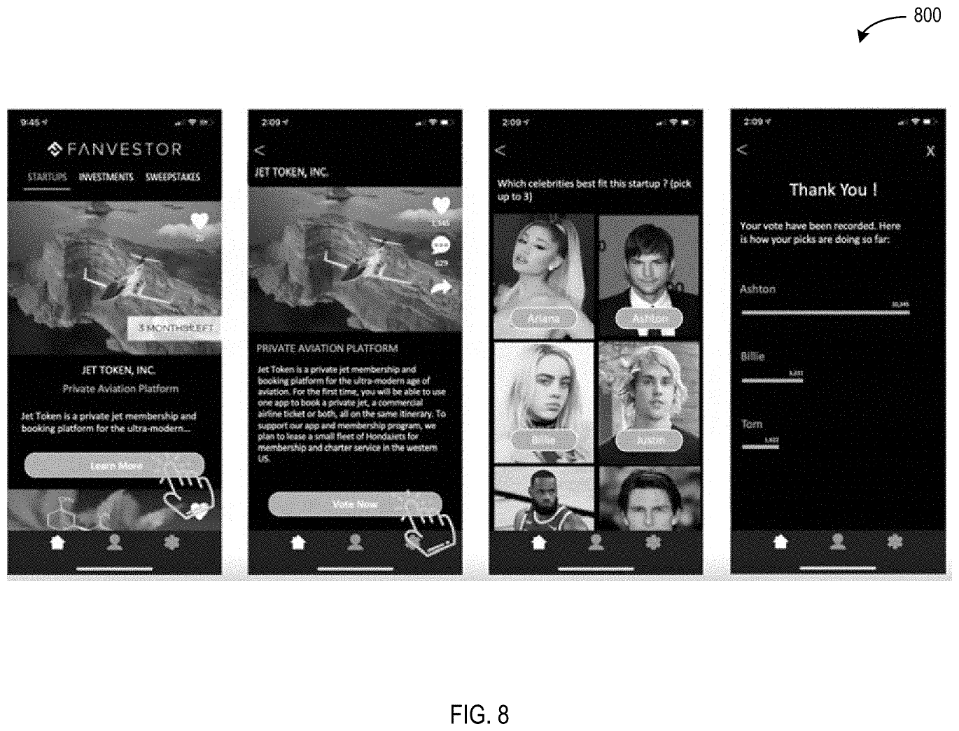

The crowdsourced selection engine 234 is intended to represent an engine that can select or identify potential representatives for a company (e.g., for a campaign on the machine learning-based digital exchange platform system 104). For example, fan users can vote on which celebrity would be the best representative for a brand, and the data can be stored as crowdsource information 264. An example is shown in FIG. 8.

The presentation engine 236 is intended to represent an engine that presents audio, visual, and/or haptic information. In some embodiments, the presentation engine 236 generates graphical user interface components (e.g., server-side graphical user interface components) that can be rendered as complete graphical user interfaces on remote systems (e.g., brand user systems, fan user systems).

The communication engine 238 is intended to represent an engine that sends requests, transmits and, receives communications, and/or otherwise provides communication with one or more of the systems, engines, devices and/or datastores described herein. In a specific implementation, the communication engine 238 can function to encrypt and decrypt communications. The communication engine 238 can function to send requests to and receive data from one or more systems through a network or a portion of a network (e.g., CRM 102). In a specific implementation, the communication engine 238 can send requests and receive data through a connection, all or a portion of which can be a wireless connection. The communication engine 238 can request and receive messages, and/or other communications from associated systems and/or engines. Communications can be stored in the machine learning-based digital exchange platform system datastore 242.

In a specific implementation, the communication engine 238 is intended to represent an engine that provides next-generation communication for machine learning-based digital exchange platform system users to increase brand-to-fan engagement. The communication engine 238 can also include an integrated web-based platform with a virtual call centers, scalable, text, voice, bot, a cloud-based, multi-channel communication platform built on top of the communication engine 238, such as for example, Twilio and the like, and hosted within a distributed on-demand cloud computing platform, such as, for example Microsoft Azure Cloud, Amazon Web Services (AWS), and the like. The machine learning-based digital exchange platform system 104 users can be able to share information via the news feed, get real-time feedback via comments, likes, and reactions, and the communication engine 238 can automatically categorizes and correlates a fanbase into relevant or fanbase-groups, incorporates live video for more immediate, direct and authentic sharing. The communication engine 238 can also include an auto-translation feature that allows for global multi-lingual communication.

The campaign manager engine 240 is intended to represent an engine that creates, reads, updates, deletes, and otherwise manages campaigns. Campaigns allow brand users to efficiently and securely raise capital by issuing assets associated with the brands. Campaigns can be created by the campaign manager engine 240 in response to input provided by a brand user for one or more brands. For example, a musician John Doe, or the musician's label company (e.g., Acme Recording Studios), can create separate campaigns from multiple upcoming albums to be released, or it can create a single campaign for all the albums. The campaign can include the asset types associated with the brand, the number of assets to be issued, an initial offering price of the assets, and the like. The initial offering price can be machine learning generated (e.g., by the machine learning-based asset value estimation engine 214). The campaign manager engine 240 can provide a dashboard or other graphical user interface (e.g., by cooperating with the presentation engine 236, discussed below) that brands users and/or fan users can access to view information about a campaign, information about the assets, set rewards, view reward history, and the like.

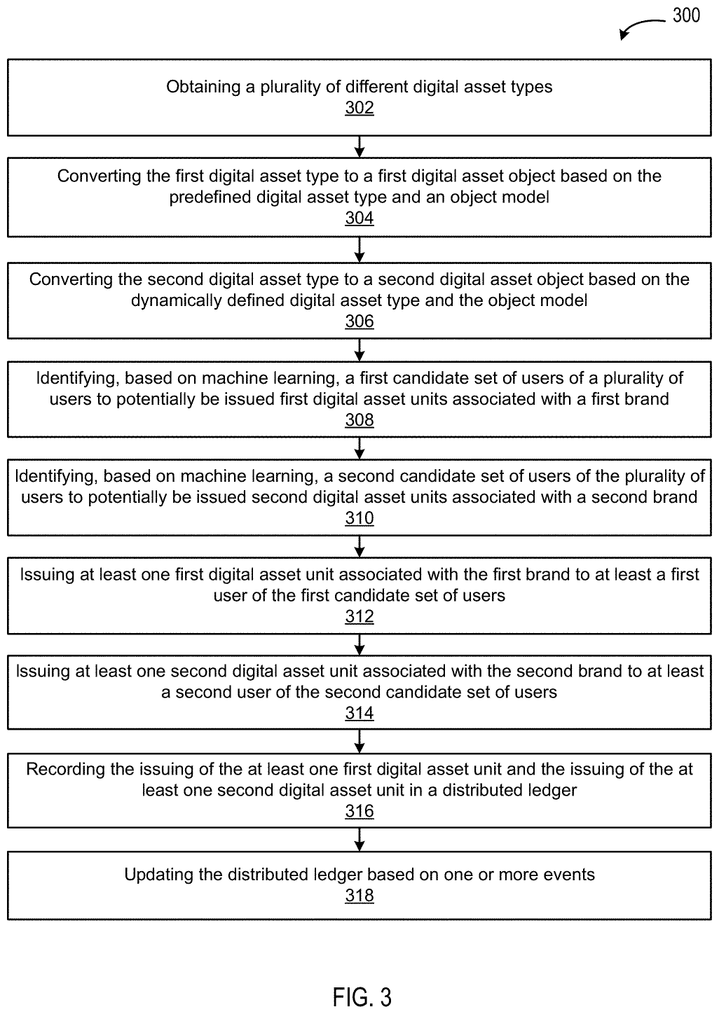

FIG. 3 is a flowchart 300 of an example of a method of operation of a machine learning-based digital exchange platform system. In this and other flowcharts and/or sequence diagrams, the flowchart illustrates by way of example a sequence of modules. It should be understood the modules may be reorganized for parallel execution, or reordered, as applicable. Moreover, some modules that could have been included may have been removed to avoid providing too much information for the sake of clarity and some modules that were included could be removed, but may have been included for the sake of illustrative clarity.

In module 302, a machine learning-based digital exchange platform system obtains a plurality of different digital asset types. At least a first digital asset type of the plurality of different digital asset types comprises a predefined digital asset type, and at least a second digital asset type of the plurality of different digital asset types comprises a dynamically defined digital asset type. An asset definition engine can obtain (e.g., define or retrieve) the plurality of different digital asset types.

In module 304, the machine learning-based digital exchange platform system converts the first digital asset type to a first digital asset object based on the predefined digital asset type and an object model. An asset conversion engine can perform the conversion based on the object model.

In module 306, the machine learning-based digital exchange platform system converts the second digital asset type to a second digital asset object based on the dynamically defined digital asset type and the object model. The asset conversion engine can perform the conversion based on the object model.

In module 308, the machine learning-based digital exchange platform system identifies, based on machine learning, a first candidate set of users of a plurality of users to potentially be issued first digital asset units associated with a first brand. Each of the first digital asset units comprises a corresponding instance of the first digital asset object. A machine learning-based candidate user identification engine can identify the first candidate set of users.

In module 310, the machine learning-based digital exchange platform system identifies, based on machine learning, a second candidate set of users of the plurality of users to potentially be issued second digital asset units associated with a second brand. Each the second digital asset units comprises a corresponding instance of the second digital asset object. The machine learning-based candidate user identification engine can identify the second candidate set of users.

In module 312, the machine learning-based digital exchange platform system issues at least one first digital asset unit associated with the first brand to at least a first user of the first candidate set of users. An asset issuance engine can issue the at least one first digital asset unit.

In module 314, the machine learning-based digital exchange platform system issues at least one second digital asset unit associated with the second brand to at least a second user of the second candidate set of users. The asset issuance engine can issue the at least one second digital asset unit.

In module 316, the machine learning-based digital exchange platform system records the issuing of the at least one first digital asset units and the issuing of the at least one second digital asset unit in a distributed ledger. A distributed ledger engine can record the issuing of the at least one first digital asset unit and the at least one second digital asset unit in the distributed ledger.

In module 318, the machine learning-based digital exchange platform system updates the distributed ledger based on one or more events. For example, events can include subsequent transactions (e.g., trades) and the like. The distributed ledger engine can update the distributed ledger based on the one or more events.

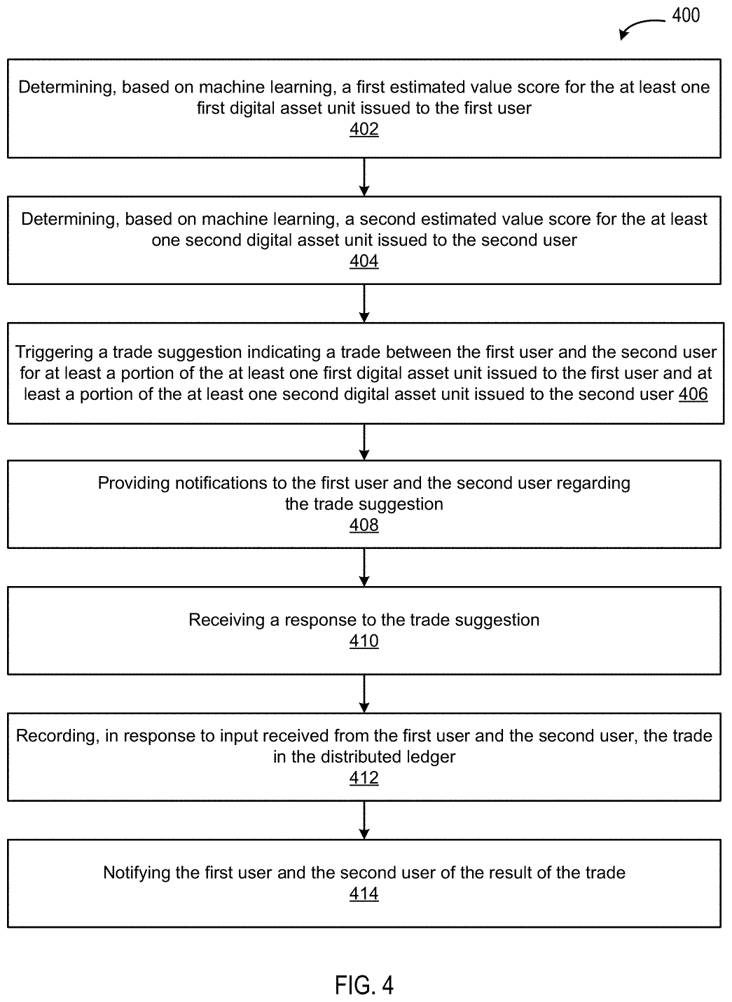

FIG. 4 is a flowchart 400 of an example of a method of using machine learning to estimate digital asset value scores and suggest and process trades of different types of digital assets on a blockchain. In this and other flowcharts and/or sequence diagrams, the flowchart illustrates by way of example a sequence of modules. It should be understood the modules may be reorganized for parallel execution, or reordered, as applicable. Moreover, some modules that could have been included may have been removed to avoid providing too much information for the sake of clarity and some modules that were included could be removed, but may have been included for the sake of illustrative clarity.

In module 402, a machine learning-based digital exchange platform system determines, based on machine learning, a first estimated value score for the at least one first digital asset unit issued to the first user. The first estimated value score can be recorded in a distributed ledger and/or asset objects. A machine learning-based asset value estimation engine can determine the first estimated value score. A distributed ledger engine can record the estimated value score in a distributed ledger. An asset definition engine can record the estimated value score in an asset object.

In module 404, the machine learning-based digital exchange platform system determines, based on machine learning, a second estimated value score for the at least one second digital asset unit issued to the second user. The first estimated value score can be recorded in a distributed ledger and/or asset objects. The distributed ledger engine can record the estimated value score in a distributed ledger. The asset definition engine can record the estimated value score in an asset object.

In module 406, the machine learning-based digital exchange platform system triggers a trade suggestion indicating a trade between the first user and a second user for at least a portion of the at least one first digital asset unit issued to the first user and at least a portion of the at least one second digital asset unit issued to the second user. An asset trade engine can trigger and suggest the trade based on machine learning.

In module 408, the machine learning-based digital exchange platform system provides notifications to the first user and the second user regarding the suggested trade. A notification engine can generate the notifications. A communication engine can provide the notifications to remote systems (e.g., fan system and a brand system associated with the first user and the second user) over a network.

In module 410, the machine learning-based digital exchange platform system receives a response to trade suggestion. The response can be NULL (no response received), trade accepted, or trade rejected. The communication engine can receive the request and forward to the asset trade engine for processing (e.g., determining whether to accept or reject the trade-based om the response(s)).

In module 412, the machine learning-based digital exchange platform system records, in response to input received from the first user and the second user, the trade in the distributed ledger. If the trade is accepted by all parties (e.g., the first user and the second user) the trade is accepted and recorded in the leger accordingly. If the trade is rejected by any of the parties (e.g., the first user or the second user), the trade is rejected and recorded in the ledger accordingly. If a NULL response is received, the trade is rejected and recorded in the distributed ledger accordingly. The distributed ledger engine can record the result of the trade. For example, if accepted, the distributed ledger can indicate the successful trading of the assets, or an unsuccessful trading of the assets.

In module 414, the machine learning-based digital exchange platform system notifies the first and the second user of the result of the trade (e.g., accepted or rejected). The notification engine can generate the notifications and the communication engine can provide the notifications to the first and second users.

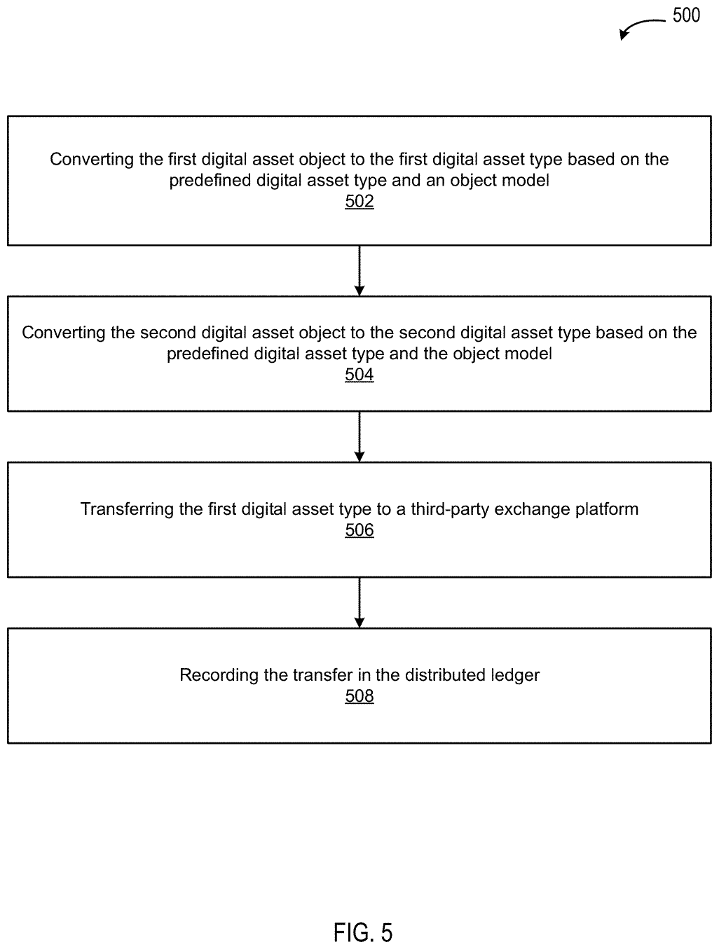

FIG. 5 is a flowchart 500 of an example of a method of transferring digital assets from the machine learning-based digital exchange platform system to a third-party exchange system. In this and other flowcharts and/or sequence diagrams, the flowchart illustrates by way of example a sequence of modules. It should be understood the modules may be reorganized for parallel execution, or reordered, as applicable. Moreover, some modules that could have been included may have been removed to avoid providing too much information for the sake of clarity and some modules that were included could be removed, but may have been included for the sake of illustrative clarity.

In module 502, a machine learning-based digital exchange platform system converts the first digital asset object to the first digital asset type based on the predefined digital asset type and an object model. An asset conversion engine can perform the conversion.

In module 504, a machine learning-based digital exchange platform system converts the second digital asset object to the second digital asset type based on the predefined digital asset type and the object model. The asset conversion engine can perform the conversion.

In module 506, the machine learning-based digital exchange platform system transfers the first digital asset type to a third-party exchange platform. An asset exchange transfer engine can perform the transfer.

In module 508, the machine learning-based digital exchange platform system records the transfer in the distributed ledger. A distributed ledger engine can record the transfer.

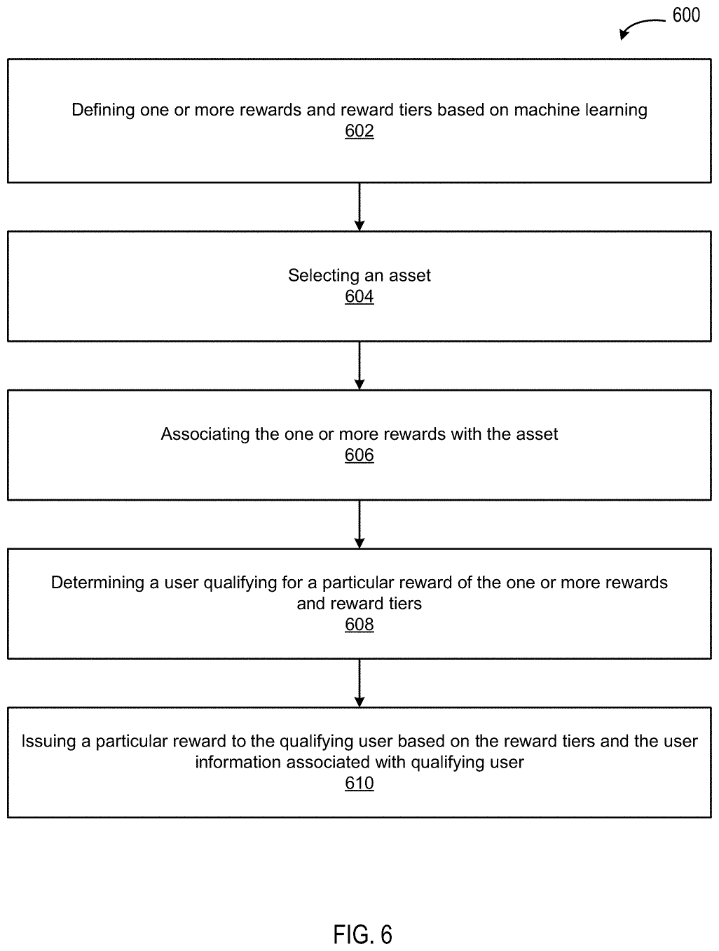

FIG. 6 is a flowchart 600 of an example of a method of issuing asset rewards based on machine learning. In this and other flowcharts and/or sequence diagrams, the flowchart illustrates by way of example a sequence of modules. It should be understood the modules may be reorganized for parallel execution, or reordered, as applicable. Moreover, some modules that could have been included may have been removed to avoid providing too much information for the sake of clarity and some modules that were included could be removed, but may have been included for the sake of illustrative clarity.

In module 602, a machine learning-based digital exchange platform system defines one or more rewards and reward tiers based on machine learning. A machine learning-based rewards engine can define the rewards and reward tiers.

In module 604, the machine learning-based digital exchange platform system selects an asset. The machine learning-based rewards engine can select the asset.

In module 606, the machine learning-based digital exchange platform system associates the one or more rewards with the asset. The machine learning-based rewards engine can associate the one or more rewards with the asset.

In module 608, the machine learning-based digital exchange platform system determines a user qualifying for a particular reward of the one or more rewards and reward tiers. The machine learning-based rewards engine can determine the qualifying user.

In module 610, the machine learning-based digital exchange platform system issues a particular reward to the qualifying user based on the reward tiers and the user information associated with qualifying user. The machine learning-based rewards engine can issue the particular reward.

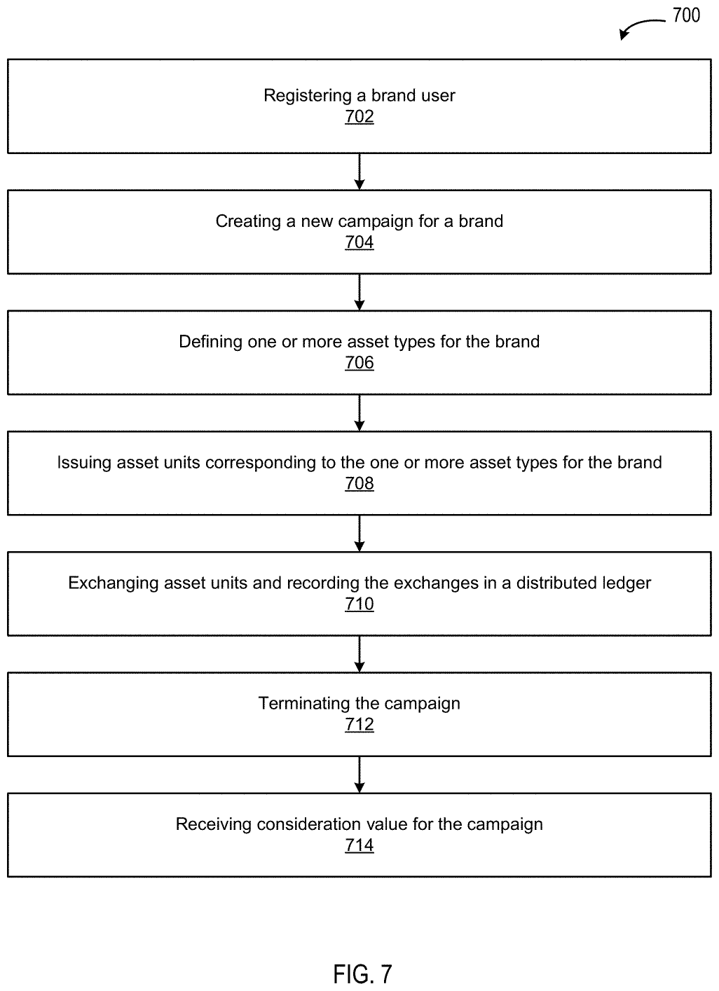

FIG. 7 is a flowchart 700 of an example of a method of managing a brand campaign. In this and other flowcharts and/or sequence diagrams, the flowchart illustrates by way of example a sequence of modules. It should be understood the modules may be reorganized for parallel execution, or reordered, as applicable. Moreover, some modules that could have been included may have been removed to avoid providing too much information for the sake of clarity and some modules that were included could be removed, but may have been included for the sake of illustrative clarity.

In module 702, a machine learning-based digital exchange platform system registers a brand user. A management engine can register the brand user.

In module 704, the machine learning-based digital exchange platform system creates a new campaign for a brand. A campaign manager engine can create the new campaign for the brand.

In module 706, the machine learning-based digital exchange platform system defines one or more asset types for the brand. An asset definition engine can define the more asset types for the brand.

In module 708, the machine learning-based digital exchange platform system issues assets units corresponding the one or more asset types for the brand. An asset issuance engine can issue the asset units.

In module 710, the machine learning-based digital exchange platform system exchanges asset units and records the exchanges in a distributed ledger. An asset trade engine can exchange the asset units and a distributed ledger engine can record the exchanges.

In module 712, the machine learning-based digital exchange platform system terminates the campaign. For example, the machine learning-based digital exchange platform system can terminate the campaign at a predetermined time (e.g., at launch of the brand) or other terminating event (e.g., not enough capital raised, not enough exchange activity). The campaign manager engine can terminate the campaign.

In module 714, the machine learning-based digital exchange platform system receives consideration value for the campaign. For example, the machine learning-based digital exchange platform system 104 can receive a fixed amount or a percentage of capital raised. For example, if $1,000,000 is raised, the machine learning-based digital exchange platform system 104 can receive a percentage (e.g., 1%) of the amount raised. A payment processing engine can receive and process the consideration value for the campaign.

FIG. 8 is a screenshot 800 of an example of an interface associated with a crowdsourced selection of a representative for a brand. As shown, users can vote on various celebrities to represent (e.g., be a spokesperson) for Jet Token, Inc. Ashton has received the most votes, and the machine learning-based digital exchange platform system 104 can notify Ashton that he has been selected by fans to represent Jet Token, Inc. If the company uses the machine learning-based digital exchange platform system 104 to raise capital (e.g., by issuing assets) Ashton may receive compensation (e.g., as a percentage of capital raised) through the machine learning-based digital exchange platform system 104.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A system comprising:
one or more processors;
memory storing instructions that, when executed by the one or more processors, cause the system to perform:
obtaining a plurality of different digital asset types, at least a first digital asset type of the plurality of different digital asset types comprising a predefined digital asset type, and at least a second digital asset type of the plurality of different digital asset types comprising a dynamically defined digital asset type;
converting the first digital asset type to a first digital asset object based on the predefined digital asset type and an object model;
converting the second digital asset type to a second digital asset object based on the dynamically defined digital asset type and the object model;
identifying, based on machine learning, a first candidate set of users of a plurality of users to potentially be issued first digital asset units associated with a first brand, each of the first digital asset units comprising a corresponding instance of the first digital asset object;
identifying, based on machine learning, a second candidate set of users of the plurality of users to potentially be issued second digital asset units associated with a second brand, each of the second digital asset units comprising a corresponding instance of the second digital asset object;
issuing at least one first digital asset unit associated with the first brand to at least a first user of the first candidate set of users;
issuing at least one second digital asset unit associated with the second brand to at least a second user of the second candidate set of users;
recording the issuing of the first digital asset units and the issuing of the second digital asset units in a distributed ledger;
updating the distributed ledger based on one or more events.

2. The system of claim 1, wherein the issuing of the first digital asset units and the issuing of the second digital asset units is based on corresponding responses from the first user and the second user.

3. The system of claim 1, wherein the distributed ledger comprises a blockchain.

4. The system of claim 1, wherein the instructions further cause the system to perform:
determining, based on machine learning, a first estimated value score for the at least one first digital asset unit issued to the first user;
determining, based on machine learning, a second estimated value score for the at least one second digital asset unit issued to the second user;
triggering a trade suggestion indicating a trade between the first user and the second user for at least a portion of the at least one first digital asset unit issued to the first user and at least a portion of the at least one second digital asset unit issued to the second user;
recording, in response to input received from the first user and the second user, the trade in the distributed ledger.

5. The system of claim 1, wherein the predefined digital asset type is predefined based on one or more third-party requirements.

6. The system of claim 1, wherein the dynamically defined digital asset type is dynamically defined by a brand user associated with the second brand via a graphical user interface (GUI).

7. The system of claim 1, wherein the instructions further cause the system to perform:
converting the first digital asset object to the first digital asset type based on the predefined digital asset type and an object model;
transferring the first digital asset type to a third-party exchange platform.

8. A method implemented by a computing system including one or more processors and storage media storing machine-readable instructions, wherein the method is performed using the one or more processors, the method comprising:
obtaining a plurality of different digital asset types, at least a first digital asset type of the plurality of different digital asset types comprising a predefined digital asset type, and at least a second digital asset type of the plurality of different digital asset types comprising a dynamically defined digital asset type;
converting the first digital asset type to a first digital asset object based on the predefined digital asset type and an object model;
converting the second digital asset type to a second digital asset object based on the dynamically defined digital asset type and the object model;
identifying, based on machine learning, a first candidate set of users of a plurality of users to potentially be issued first digital asset units associated with a first brand, each of the first digital asset units comprising a corresponding instance of the first digital asset object;
identifying, based on machine learning, a second candidate set of users of the plurality of users to potentially be issued second digital asset units associated with a second brand, each of the second digital asset units comprising a corresponding instance of the second digital asset object;
issuing at least one first digital asset unit associated with the first brand to at least a first user of the first candidate set of users;
issuing at least one second digital asset unit associated with the second brand to at least a second user of the second candidate set of users;
recording the issuing of the first digital asset units and the issuing of the second digital asset units in a distributed ledger;
updating the distributed ledger based on one or more events.

9. The method of claim 8, wherein the issuing of the first digital asset units and the issuing of the second digital asset units is based on corresponding responses from the first user and the second user.

10. The method of claim 8, wherein the distributed ledger comprises a blockchain.

11. The method of claim 8, further comprising:
determining, based on machine learning, a first estimated value score for the at least one first digital asset unit issued to the first user;
determining, based on machine learning, a second estimated value score for the at least one second digital asset unit issued to the second user;
triggering a trade suggestion indicating a trade between the first user and the second user for at least a portion of the at least one first digital asset unit issued to the first user and at least a portion of the at least one second digital asset unit issued to the second user;
recording, in response to input received from the first user and the second user, the trade in the distributed ledger.

12. The method of claim 8, wherein the predefined digital asset type is predefined based on one or more third-party requirements.

13. The method of claim 8, wherein the dynamically defined digital asset type is dynamically defined by a brand user associated with the second brand via a graphical user interface (GUI).

14. The method of claim 8, further comprising:
converting the first digital asset object to the first digital asset type based on the predefined digital asset type and an object model;
transferring the first digital asset type to a third-party exchange platform.

15. A non-transitory computer readable medium comprising instructions that, when executed, cause one or more processors to perform:
obtaining a plurality of different digital asset types, at least a first digital asset type of the plurality of different digital asset types comprising a predefined digital asset type, and at least a second digital asset type of the plurality of different digital asset types comprising a dynamically defined digital asset type;
converting the first digital asset type to a first digital asset object based on the predefined digital asset type and an object model;
converting the second digital asset type to a second digital asset object based on the dynamically defined digital asset type and the object model;
identifying, based on machine learning, a first candidate set of users of a plurality of users to potentially be issued first digital asset units associated with a first brand, each of the first digital asset units comprising a corresponding instance of the first digital asset object;
identifying, based on machine learning, a second candidate set of users of the plurality of users to potentially be issued second digital asset units associated with a second brand, each of the second digital asset units comprising a corresponding instance of the second digital asset object;
issuing at least one first digital asset unit associated with the first brand to at least a first user of the first candidate set of users;
issuing at least one second digital asset unit associated with the second brand to at least a second user of the second candidate set of users;
recording the issuing of the first digital asset units and the issuing of the second digital asset units in a distributed ledger;
updating the distributed ledger based on one or more events.

16. The non-transitory computer readable medium of claim 15, wherein the issuing of the first digital asset units and the issuing of the second digital asset units is based on corresponding responses from the first user and the second user.

17. The non-transitory computer readable medium of claim 15, wherein the distributed ledger comprises a blockchain.

18. The non-transitory computer readable medium of claim 15, wherein the instructions, when executed, further cause the one or more processors to perform:
determining, based on machine learning, a first estimated value score for the at least one first digital asset unit issued to the first user;
determining, based on machine learning, a second estimated value score for the at least one second digital asset unit issued to the second user;
triggering a trade suggestion indicating a trade between the first user and the second user for at least a portion of the at least one first digital asset unit issued to the first user and at least a portion of the at least one second digital asset unit issued to the second user;
recording, in response to input received from the first user and the second user, the trade in the distributed ledger.

19. The non-transitory computer readable medium of claim 15, wherein the predefined digital asset type is predefined based on one or more third-party requirements.

20. The non-transitory computer readable medium of claim 15, wherein the dynamically defined digital asset type is dynamically defined by a brand user associated with the second brand via a graphical user interface (GUI).
